(19) United States
(12) Patent Application Publication
(10) Pub. No.: US 2017/0300215 A1
(43) Pub. Date: Oct. 19, 2017

(54) ELECTRONIC DEVICE AND METHOD FOR CONTROLLING THE SAME

(71) Applicant: CANON KABUSHIKI KAISHA, Tokyo (JP)

(72) Inventor: Takayuki Nakahama, Yokohama-shi (JP)

(21) Appl. No.: 15/482,425

(22) Filed: Apr. 7, 2017

(30) Foreign Application Priority Data
Apr. 13, 2016 (JP) 2016-080542

(51) Int. Cl. G06F 3/0484; G06F 3/041; G06F 3/0488; H04N 5/232

(52) U.S. Cl. CPC G06F 3/04845; G06F 3/04883; G06F 3/0416; G06F 2203/04806; H04N 5/23212; G06F 2203/04105

(57) ABSTRACT

An electronic device detects a touch operation on an operation unit, detects at least whether a pressing force for the operation unit is small or large, receives a movement operation of a touch position of the touch operation on the operation unit, and performs control so that a first function is executed based on receipt of the movement operation, wherein control is performed so that, in a case where a predetermined change in the pressing force is detected without a touch of the touch operation being released after the receipt of the movement operation, a second function is not executed when the predetermined change is detected, and control is performed so that, in a case where the predetermined change is detected before the movement operation, the second function is executed when the predetermined change is detected.

### BACKGROUND

### Field

The present disclosure relates to an electronic device and a method for controlling the same, and in particular, relates to a technique for executing a function based on a press on an operation unit on which a touch operation can be performed.

### Description of the Related Art

In recent years, electronic devices in which a corresponding function is assigned to an operation of moving a touch position on a touch panel are known. Electronic devices in which a corresponding function is assigned based on the strength of a press on a touch panel are also known. Japanese Patent Application Laid-Open No. 2011-034512 discusses a technique for assigning a change in the display range of a display target to an operation of moving a touch position. According to Japanese Patent Application Laid-Open No. 2011-034512, in a case where a displayed image is enlarged, the greater the enlargement ratio is, the greater the moving distance of the display range to be changed based on the movement of a touch position is changed to be, thereby enabling the movement of the display range with a smaller amount of movement operation while the image is being enlarged. Japanese Patent Application Laid-Open No. 2003-58316 discusses a technique whereby, when the operation pressure on a touch panel is weak, only a cursor is displayed, and when the operation pressure is strong, an input is finalized.

If a function is assigned to each operation of moving a touch position on an operation unit and the strength of the press on the operation unit, a user can execute various functions by performing operations on a single operation member. However, when the touch position is moved to perform the operation of moving the display range, as discussed in Japanese Patent Application Laid-Open No. 2011-034512, there is a possibility that the pressing force changes during the movement of the touch position. In this case, if a function based on the strength of the operation pressure is assigned, for example, as discussed in Japanese Patent Application Laid-Open No. 2003-58316, the strong pressing force on the operation unit can change and become weak during the movement of the touch position. At this time, in spite of the user's wanting to change the display range based on the movement of the touch position, the function based on a change in the pressing force is executed. In other words, there is a possibility that a function unintended by the user is executed.

There is also a case where, when a part of a display target is displayed, the display magnification is reduced to confirm part peripheral to the displayed part. It is possible to enable the user to provide an instruction by a press operation to perform this reduction. If, however, the user only wishes to temporarily reduce the display magnification, it is cumbersome for the user to perform an enlargement operation again after the reduction.

When changing the display magnification of the display target based on a press operation, the determination of whether the display target should be enlarged or reduced varies depending on the situation.

### SUMMARY

The present disclosure describes an electronic device that addresses at least one of the above issues, and of more suitably executing a function based on the strength of the press on an operation unit on which a touch operation can be performed.

An electronic device includes a touch detection unit configured to detect a touch operation on an operation unit, a press detection unit configured to detect at least whether a pressing force for the operation unit is small or large, a reception unit configured to receive a movement operation of a touch position of the touch operation on the operation unit, and a control unit configured to perform control so that a first function is executed based on receipt of the movement operation, wherein the control unit performs control so that, in a case where a predetermined change in the pressing force is detected without a touch of the touch operation being released after receipt of the movement operation, a second function is not executed when the predetermined change is detected, and wherein the control unit performs control so that, in a case where the predetermined change is detected before the movement operation, the second function is executed when the predetermined change is detected.

According to another aspect of the present invention, an electronic device includes a touch detection unit configured to detect a touch operation on an operation unit, a press detection unit configured to detect at least whether a pressing force for the operation unit is small or large, and a control unit configured to perform control so that, based on a predetermined change in the pressing force, a display magnification of a display target displayed on a display unit is changed, wherein the control unit performs control so that, when the display target is displayed at a first magnification, the display target is displayed at a second magnification that is smaller than the first magnification based on an increase in the pressing force, and then, based on release of a touch of the touch operation, the display target is displayed at the first magnification.

According to yet another aspect of the present invention, an electronic device includes a detection unit configured to detect a touch operation on an operation unit, a press detection unit configured to detect at least whether a pressing force for the operation unit is small or large, and a control unit configured to perform control to change a display magnification of a display target displayed on a display unit, wherein the control unit performs control so that, when the pressing force of a press on the operation unit started in a case where the display magnification of the display target is smaller than a predetermined magnification increases, the display magnification is made greater, and wherein the control unit performs control so that, when the pressing force of a press on the operation unit started in a case where the display magnification of the display target is greater than the predetermined magnification increases, the display magnification is made smaller.

Further features will become apparent from the following description of exemplary embodiments with reference to the attached drawings.

### BRIEF DESCRIPTION OF THE DRAWINGS

FIG. 1 is an external view of a digital camera as an example of an apparatus to which a configuration of an exemplary embodiment is applicable.

FIG. 2 is a block diagram illustrating an example of a configuration of the digital camera as an example of the apparatus to which the configuration of the exemplary embodiment is applicable.

FIGS. 3A and 3B are flowcharts illustrating image display processing.

FIGS. 4A and 4B are flowcharts illustrating display area change processing.

FIGS. 5A, 5B, 5C, and 5D are diagrams illustrating states of enlargement of an image in a first exemplary embodiment.

FIGS. 6A, 6B, 6C, 6D, and 6E are diagrams illustrating states where an enlarged area in an image is selected in the first exemplary embodiment.

FIGS. 7A, 7B, 7C, 7D, 7E, and 7F are diagrams illustrating states where an enlarged area in an image is selected in a second exemplary embodiment.

FIGS. 8A, 8B, 8C, and 8D are diagrams illustrating setting screens to which an exemplary embodiment is applicable.

### DESCRIPTION OF THE EMBODIMENTS

Exemplary embodiments will be described in detail below with reference to the accompanying drawings. It is to be noted that the following exemplary embodiments are merely examples and can be appropriately modified or changed depending on individual constructions and various conditions of apparatuses of the embodiments. Thus, the following exemplary embodiments are not seen to be limiting.

A first exemplary embodiment will be described below with reference to the drawings.

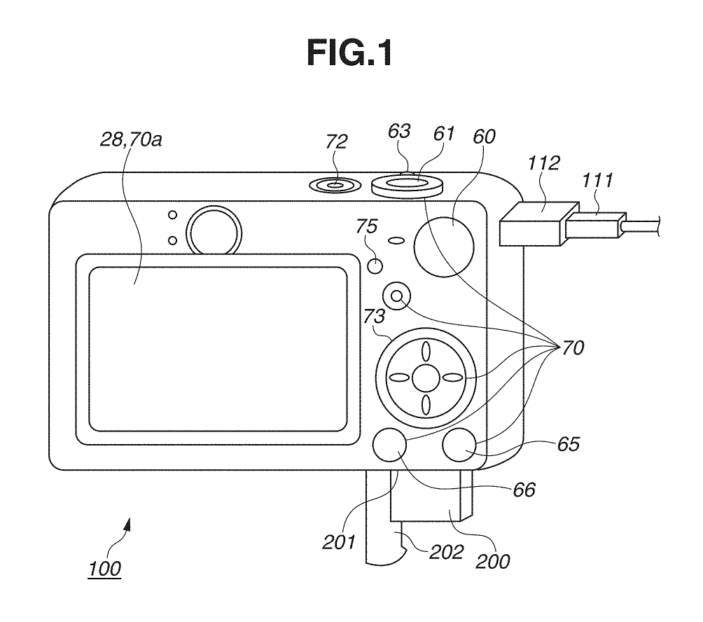

FIG. 1 illustrates an external view of a digital camera 100 as an example of an imaging control apparatus according to the present exemplary embodiment. A display unit 28 is a display unit for displaying an image and various pieces of information. On the display unit 28, a touch panel 70a and a press detection unit 70b (a pressure detection sensor) are provided in an overlapping manner. A shutter button 61 is an operation unit for providing an image capturing instruction. A magnification change lever 63 is provided around the shutter button 61. In an image capturing mode an image capturing range can be enlarged (zoom in on) by moving the lever in the right direction, and reduce (zoom out from) the image capturing range by moving the lever in the left direction.

In a reproduction mode, the magnification of an image displayed on the display unit 28 can be changed with the magnification change lever 63. An enlargement button and a reduction button 66 are members provided separately from the magnification change lever 63 and are buttons for electronically changing the magnification of an image displayed on the display unit 28 both in the image capturing mode and the reproduction mode. In the image capturing mode, however, even if either the enlargement button 65 or the reduction button 66 is operated, the image capturing range is not changed (neither the enlargement button 65 nor the reduction button 66 is used to give an instruction to perform an optical zoom).

A mode selection switch 60 is an operation unit for switching various modes. A connector 112 is a connector for connecting a connection cable 111 for connecting to the digital camera 100 to, for example, a personal computer (PC) or a printer. An operation unit 70 is an operation unit including operation members such as various switches, buttons, and a touch panel for receiving various operations from a user. A controller wheel 73 is an operation member included in the operation unit 70 and can be rotationally operated. A power switch 72 is a push button for switching the digital camera 100 on or off. A menu button 75 is a button for switching the image capturing mode to a menu screen (a menu mode) or switching the reproduction mode to the menu screen. Settings for a focus mode can be made on the menu screen. The mode selection switch 60 is a switch with which modes for a still image and a moving image can be switched.

A recording medium 200 is a non-volatile recording medium such as a memory card or a hard disk. A recording medium slot 201 is a slot for storing the recording medium 200. The recording medium 200, once stored in the recording medium slot 201, becomes communicable with the digital camera 100 and recording and reproduction can be performed. A cover 202 is a cover for the recording medium slot 201. FIG. 1 illustrates the state where the cover 202 is opened, and the recording medium 200 is partially removed from the slot 201 and exposed.

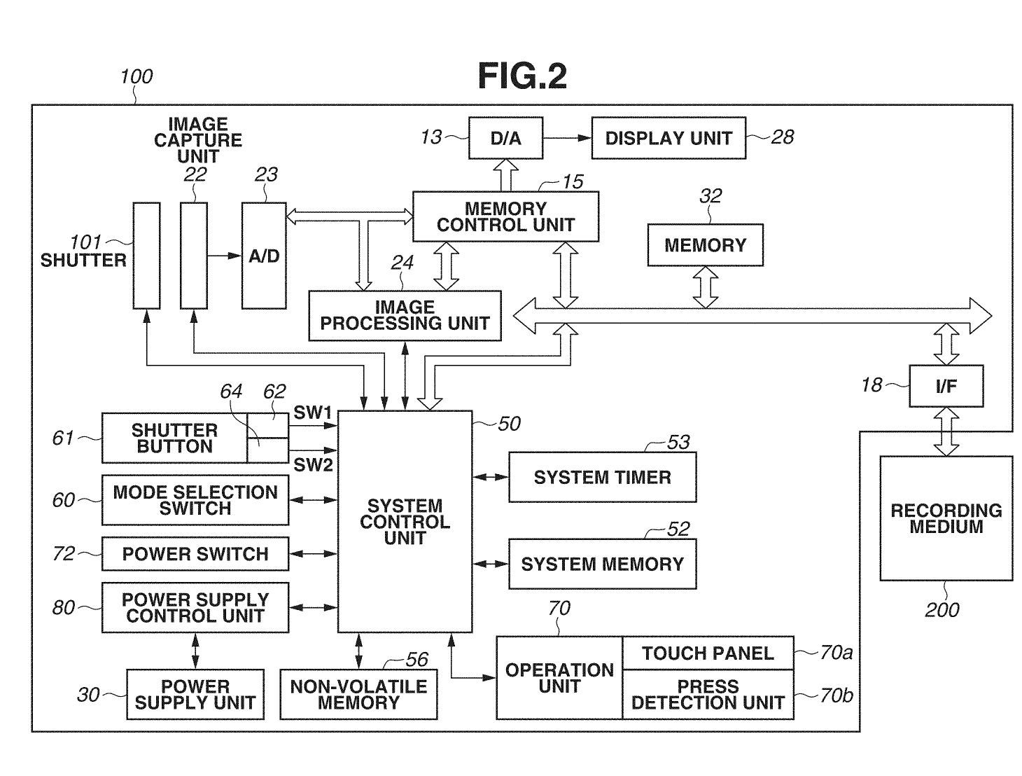

FIG. 2 is a block diagram illustrating an example of a configuration of the digital camera 100 as an example of the imaging control apparatus according to the present exemplary embodiment. A shutter 101 is a shutter including a diaphragm function. An image capture unit 22 is an image sensor including a charge-coupled device (CCD) sensor or a complementary metal-oxide-semiconductor (CMOS) sensor that converts an optical image into an electric signal. An analog-to-digital (A/D) converter 23 converts an analog signal into a digital signal. The A/D converter 23 is used to convert an analog signal output from the image capture unit 22 into a digital signal.

An image processing unit 24 performs predetermined resizing processes, such as pixel interpolation and reduction, and a predetermined color conversion process on data from the A/D converter 23 or data from a memory control unit 15. The image processing unit 24 also performs a predetermined calculation process using captured image data. Then, a system control unit 50 performs exposure control and distance measurement control based on the calculation result obtained through the calculation process. In this way, an autofocus (AF) process, an automatic exposure (AE) process, and a pre-flash (EF) process by a through-the-lens (TTL) method are performed. The image processing unit 24 performs a predetermined calculation process using captured image data and performs an auto white balance (AWB) process by the TTL method based on the calculation result obtained through the calculation process.

Output data from the A/D converter 23 is written directly in a memory 32 via the image processing unit 24 and the memory control unit 15 or via the memory control unit 15. The memory 32 stores image data captured by the image capture unit 22 and converted into digital data by the A/D converter 23, and image data to be displayed on the display unit 28. The memory 32 includes sufficient storage capacity for storing a predetermined number of still images, and moving images and sounds of a predetermined length of time.

The memory 32 also serves as a memory for image display (a video memory). A digital-to-analog (D/A) converter 13 converts data for image display stored in the memory 32 into an analog signal and supplies the analog signal to the display unit 28. In this way, image data for display written in the memory 32 is displayed on the display unit 28 via the D/A converter 13. The display unit 28 performs display on a display device, such as a liquid crystal display (LCD), based on an analog signal from the D/A converter 13. Analog signals are once converted into digital signals by the A/D converter 23, and the digital signals are accumulated in the memory 32 and converted into analog signals by the D/A converter 13. Then, the analog signals are sequentially transferred to and displayed on the display unit 28, whereby the display unit 28 functions as an electronic viewfinder and can perform through image display (live view display).

A non-volatile memory 56 is a memory as an electrically erasable and recordable recording medium. As the non-volatile memory 56, for example, an Electrically Erasable Programmable Read-Only Memory (EEPROM) is used. The non-volatile memory 56 stores a constant for the operation of the system control unit 50 and a program. The term “program” used herein refers to a computer program for executing the processing of various flow charts described below in the present exemplary embodiment.

The system control unit 50 controls the entire digital camera 100. The system control unit 50 achieves the processes described below in the present exemplary embodiment by executing the aforementioned program stored in the non-volatile memory 56. As a system memory 52, a random-access memory (RAM) is used. A constant and a variable for the operation of the system control unit 50 and a program read from the non-volatile memory 56 are loaded into the system memory 52. The system control unit 50 also performs display control by controlling the memory 32, the D/A converter 13, and the display unit 28. The mode selection switch 60, the shutter button 61, and the operation unit 70 are operation means for inputting various operation instructions to the system control unit 50.

The mode selection switch 60 switches the operation mode of the system control unit 50 to any one of a still image recording mode, a moving image capturing mode, or the reproduction mode. The still image recording mode includes modes such as an auto image capturing mode, an auto scene determination mode, a manual mode, various scene modes in which image capturing settings are made based on image capturing scenes, a program AE mode, and a custom mode. The still image recording mode is directly switched to any one of these modes using the mode selection switch 60. Alternatively, after the still image recording mode is once switched to the menu screen using the mode selection switch 60, the still image recording mode can be, using another operation member, switched to any one of these modes included in the menu screen. Similarly, the moving image capturing mode can also include a plurality of modes.

A first shutter switch 62 is turned on in an intermediate state of the operation, i.e., a so-called half press (an image capturing preparation instruction) of the shutter button 61 provided in the digital camera 100 and generates a first shutter switch signal SW1. Based on the first shutter switch signal SW1, the system control unit 50 starts the operation of an AF process, an AE process, an AWB process, or an EF process.

A second shutter switch 64 is turned on by the completion of the operation, i.e., a so-called full press (an image capturing instruction), of the shutter button 61 and generates a second shutter switch signal SW2. Based on the second shutter switch signal SW2, the system control unit 50 starts a series of operations of an image capturing process from the reading of a signal from the image capture unit 22 to the writing of image data to the recording medium 200.

The operation members of the operation unit 70 are appropriately assigned with functions for corresponding scenes by, for example, selecting various function icons displayed on the display unit 28 and then act as various function buttons. The function buttons include, for example, an end button, a return button, an advance-image button, a jump button, a narrow-down button, and a change-attributes button. When, for example, the menu button 75 is pressed, the menu screen where various settings can be made is displayed on the display unit 28. The user can intuitively make various settings using the menu screen displayed on the display unit 28, a four-direction (up, down, left, and right directions) button, and a SET button.

The operation unit 70 includes, as operation members, the touch panel 70a that can detect contact with (detect a “touch on”) the display unit 28, and the press detection unit 70b that can detect the press on the display unit 28. The touch panel 70a, the press detection unit 70b, and the display unit 28 can be formed in an integrated manner. For example, the touch panel 70a is configured so that the transmittance of light does not hinder the display of the display unit 28. The touch panel 70a is attached to an upper layer of the display surface of the display unit 28. Input coordinates on the touch panel 70a are associated with display coordinates on the display unit 28. The press detection unit 70b can be placed on the upper layer of the display unit 28 similarly to the touch panel 70a, or can be placed on a lower layer of the display unit 28. In a case where the press detection unit 70b is placed on the upper layer, the press detection unit 70b is configured not to hinder the display of the display unit 28. Consequently, a graphical user interface (GUI) can be configured as if the user can directly operate a screen displayed on the display unit 28.

The system control unit 50 can detect the following operations on the touch panel 70a or the following states:

the state where a finger or a pen/stylus previously had not touched the touch panel 70a newly touches the touch panel 70a, i.e., the start of a touch (hereinafter referred to as a “touch-down”).
the state where a finger or a pen/stylus touches the touch panel 70a (hereinafter referred to as a “touch-on”).
the state of moving a finger or pen/stylus while the finger or the pen/stylus maintains contact (keeps touching) the touch panel 70a (hereinafter referred to as a “touch move”).
the state of releasing from the touch panel 70a a finger or a pen/stylus touching the touch panel 70a, i.e., the end of a touch (hereinafter referred to as a “touch-up”).
the state where nothing is in contact with (nothing touching) the touch panel 70a (hereinafter referred to as a “touch-off”).

The system control unit 50 can detect the following operations on the press detection unit 70b or the following states:
the state where the press detection unit 70b is pushed in in the state where a “touch-down” or a “touch-on” is performed on the press detection unit 70b (a press), the pressing force of the press, and whether the pressing force is small or large (whether the pressing force is greater or less than a predetermined pressing force). If the pressing force is greater than or equal to a predetermined pressure, it is determined that the press detection unit 70b is pressed.

The touch panel 70a, the press detection unit 70b, and the display unit 28 are provided in an overlapping manner (or as the same member). The touch panel 70a and the press detection unit 70b can detect touch-related operations (a touch operation and a press) on this set of operation members that can receive a touch operation and a press. If the user performs a touch operation and a press operation on an operation surface, the touch panel 70a can detect the touch operation, and the press detection unit 70b can detect the press. In other words, if the user performs a touch operation on and applies a pressing force to a candidate from among the set of operation members in which the touch panel 70a and the press detection unit 70b overlap each other, each operation is detected. The press detection unit 70b can detect the press on the touch panel 70a or the display unit 28.

If a “touch-down” is detected, simultaneously, a “touch-on” is detected. After a “touch-down” or a “touch-on”, if detected pressure greater than or equal to a predetermined magnitude, the current state is a press state. Typically, the “touch-on” or the press state continues to be detected unless a “touch-up” is detected. A “touch move” is also detected in the state where a “touch-on” is detected. Even if a “touch-on” is detected, but the touch position does not move, a “touch move” is not detected. After a “touch-up” of any fingers or pen/stylus that touched the touch panel 70a or the press detection unit 70b is detected, a “touch-off” is detected.

As described above, it can be determined that the current state is a press state either when the detected pressing force is greater than or equal to a predetermined magnitude or when a change in a pressing force is greater than or equal a predetermined magnitude. The system control unit 50 determines, by detecting the pressing force on the touch panel 70a every predetermined time or at all times, that the current state is a press state (or a non-press state) either when the detected pressing force is greater than or equal to (or less than) a predetermined magnitude or when a change in a pressing force is increased (or decreased). Even in a press state, it is possible to receive an operation involving the movement of the touch position.

The system control unit 50 is notified via an internal bus of these operations and states and the position coordinates where the finger or the pen/stylus touches the touch panel 70a. Based on the notified information, the system control unit 50 determines what operation is performed on the touch panel 70a. In the case of a “touch move”, the system control unit 50 can also determine, based on changes in the position coordinates, the moving direction of the finger or the pen/stylus moving on the touch panel 70a with respect to each of the vertical and horizontal components on the touch panel 70a. If the user continuously performs a “touch-down”, a certain “touch move”, and a “touch-up” on the touch panel 70a, this the user is considered to have drawn a stroke. The operation of quickly drawing a stroke is referred to as a “flick”. A “flick” is the operation of quickly moving a finger or pen/stylus a certain distance while the finger or pen/stylus maintains contact (keeps touching) with the touch panel 70a, and then releasing the finger or pen/stylus from the touch panel 70a immediately after the quick movement. In other words, a “flick” is the operation of quickly tracing the touch panel 70a with a finger or pen/stylus in a flipping manner.

If a “touch move” performed by a predetermined distance or more at a predetermined speed or more is detected, and a “touch-up” is detected immediately after the “touch move”, the system control unit 50 determines that a “flick” has been performed. If a “touch move” performed by a predetermined distance or more at less than a predetermined speed is detected, the system control unit 50 determines that a “drag” is performed. A touch on the touch panel 70a can be detected using a touch panel of any of various types, such as an electrostatic capacitance type, a surface acoustic wave type, an infrared type, an electromagnetic induction type, an image recognition type, or a photosensor type.

A power supply control unit 80 includes a battery detection circuit, a direct-current-to-direct-current (DC/DC) converter, and a switch circuit for switching blocks to which to apply a current. The power supply control unit 80 detects the presence or absence of attachment of a battery, the type of a battery, and the remaining life of a battery. The power supply control unit 80 controls the DC/DC converter based on these detection results and an instruction from the system control unit 50 and supplies a required voltage to the components including the recording medium 200 for a required period of time. Based on switching of the power switch 72, the power switch notifies the system control unit 50 that the power switch 72 has entered an on state or an off state.

A power supply unit 30 includes a primary battery such as an alkaline battery or a lithium battery, a secondary battery such as a nickel-cadmium (NiCd) battery, a nickel-metal hydrate (NiMH) battery, or a lithium-ion (Li) battery, or an alternating current (AC) adapter. A recording medium interface (I/F) 18 is an interface with the recording medium 200, such as a memory card or a hard disk. The recording medium 200 is a non-volatile recording medium, such as a memory card, for recording a captured image and includes a semiconductor memory, an optical disc, or a magnetic disk.

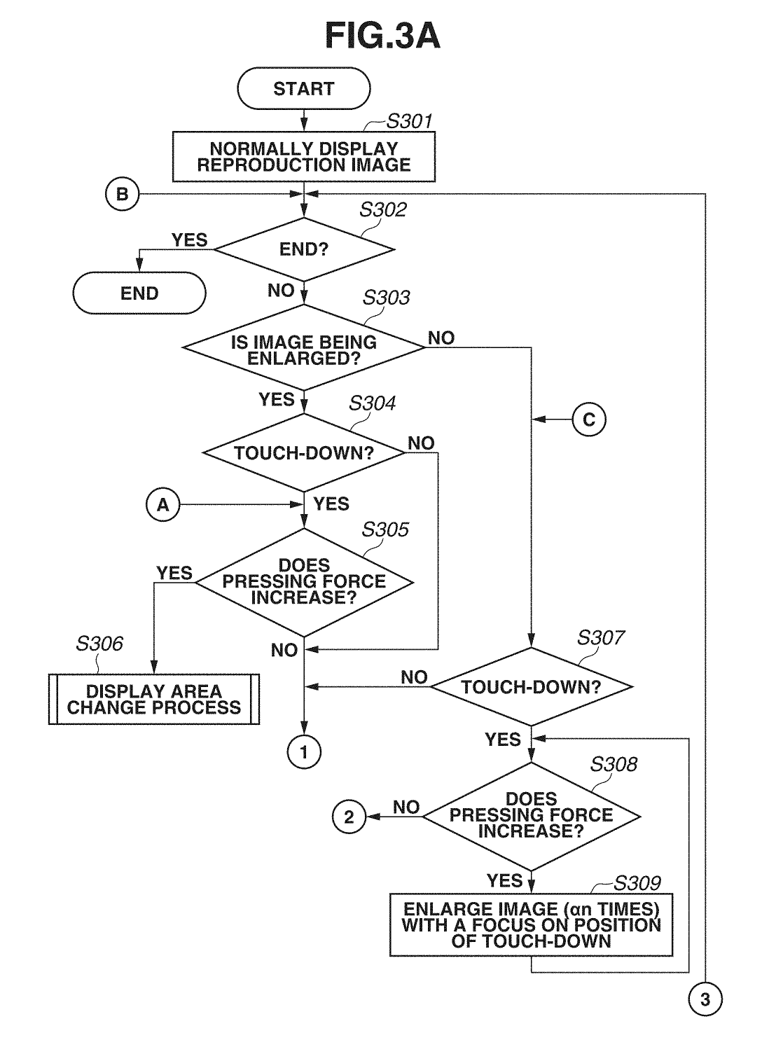

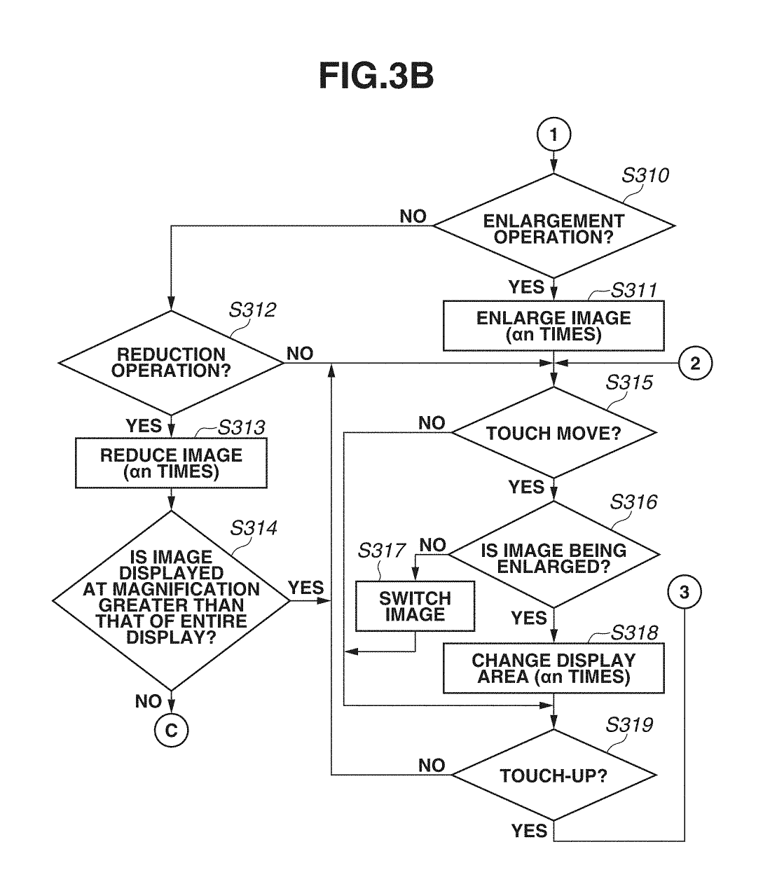

An image display process according to the present exemplary embodiment will now be described with reference to the flowcharts of FIGS. 3A and 3B. This processing is achieved by loading a program recorded in the non-volatile memory 56 into the system memory 52 and by the system control unit 50 executing the program. This processing is started when the digital camera 100 is turned on, and the operation mode transitions to the reproduction mode.

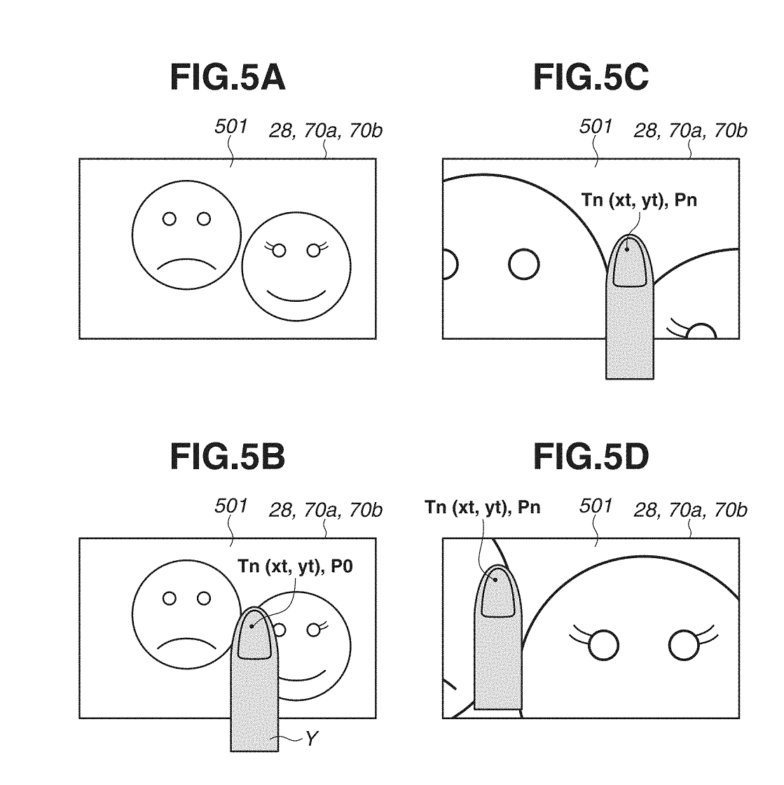

In step S301, the system control unit 50 displays a reproduction image as a display target on the display unit 28. FIG. 5A illustrates an example of display of a reproduction image 501 in a single reproduction in which an image recorded in the recording medium 200 is reproduced. The display magnification of an image when the operation mode transitions to the reproduction mode and a single reproduction (the state where a single image is displayed on the display unit 28) is performed is set as a reference for the display magnification of the image and set as the display magnification of entire display (a display magnification of 1 time). In the processing described below, entire display is the state where the display magnification of a reproduction image (an image) displayed on the display unit 28 is the display magnification when a single reproduction is performed (the magnification when the reproduction image is displayed on the display unit 28 in the state where the display magnification is not changed by the user). Entire display is the state where the reproduction image 501 is displayed in such a manner that at least either one of the vertical and horizontal lengths of the display area of the display unit 28 coincides with either one of the vertical and horizontal lengths of the reproduction image 501, and no area in the display area of the reproduction image 501 is hidden. In other words, entire display indicates the state where the entire area of the reproduction image 501 is displayed in the largest size in which the reproduction image 501 can be displayed. FIGS. 5A to 5E illustrate an example of a series of states when the reproduction image 501 is enlarged from entire display in the present exemplary embodiment.

In step S302, the system control unit 50 determines whether the operation of ending the image display process is performed. Examples of the process of ending the image display process include turning off of the digital camera 100, switching to the menu mode or an image capturing mode, and auto shut-off due to a no-operation state continuing for a predetermined time. If it is determined that the operation of ending the image display process is performed (YES in step S302), the image display process ends. If it is not determined that the operation of ending the image display process is performed (NO in step S302), the processing proceeds to step S303.

In step S303, the system control unit 50 determines whether the reproduction image 501 displayed on the display unit 28 is being subjected to enlarged display (in the state where the reproduction image 501 is displayed by being enlarged relative to entire display). If it is determined that the reproduction image 501 is being subjected to enlarged display (YES in step S303), the processing proceeds to step S304. If it is not determined that the reproduction image 501 is being subjected to enlarged display (NO in step S303), the processing proceeds to step S307.

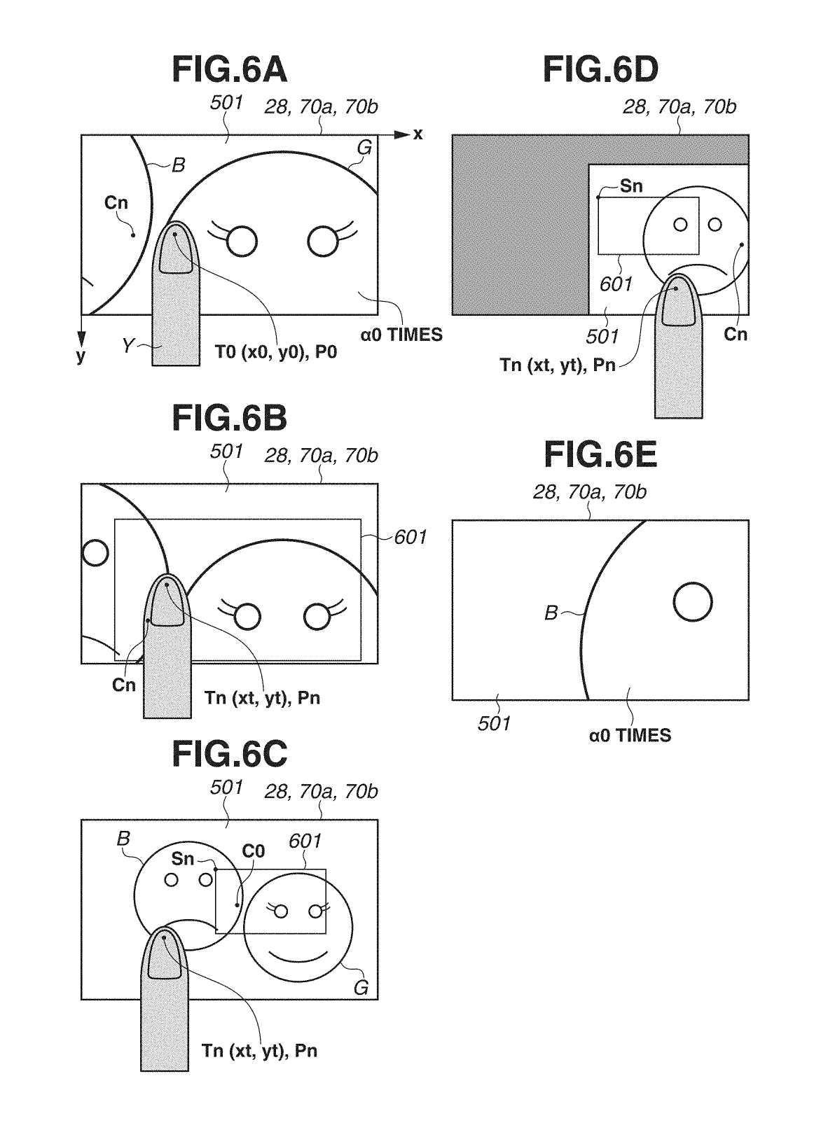

In step S304, the system control unit 50 determines whether a “touch-down” is performed (the start of a touch operation is detected) on the touch panel 70a. If it is determined that a “touch-down” is performed (YES in step S304), the processing proceeds to step S305. If it is not determined that a “touch-down” is performed (NO in step S304), the processing proceeds to step S310. As illustrated in FIG. 6A, in a case where the reproduction image 501 is being subjected to enlarged display, and if a finger Y performs a “touch-down” on the touch panel 70a (the reproduction image 501 is being enlarged when a touch is started), the determinations are YES in steps S303 and S304, and the processing proceeds to step S305. The system control unit 50 sets the position where the “touch-down” is detected as coordinates T0(X0, Y0), sets the pressing force of the touch-down as P0, and records the coordinates T0(X0, Y0) and the pressing force P0 in the system memory 52. FIGS. 6A to 6E are diagrams illustrating changes in the image capturing range in a case where a touch operation is performed by the user in the state where the reproduction image 501 is subjected to enlarged display on the display unit 28.

In step S305, the system control unit 50 determines whether the pressing force on the touch panel 70a increases. The system control unit 50 sets the current pressing force as Pn and sets the pressing force of the touch detected in the most recent step S304 or S417 as P(n−1). If the pressing force (Pn) on the touch panel 70a becomes greater than or equal to a (kg/cm2), the system control unit 50 determines that the pressing force increases relative to the pressing force of the “touch-down” performed in step S304. If the pressing force is less than a, it is likely that the user is not attempting to press the touch panel 70a, but is attempting to perform a touch operation without pressing the touch panel 70a. Thus, the system control unit 50 does not determine that the touch panel 70a is pressed. The determination of whether the pressing force increases can be made based on a change in the amount of the pressing force. For example, the pressing force of the “touch-down” is P0, and therefore, if a change ΔP(Pn−P0) in the pressing force becomes greater than or equal to a, the system control unit 50 can determine that the pressing force increases. If it is determined that the pressing force increases (YES in step S305), the processing proceeds to step S306. If it is not determined that the pressing force increases (NO in step S305), the processing proceeds to step S310.

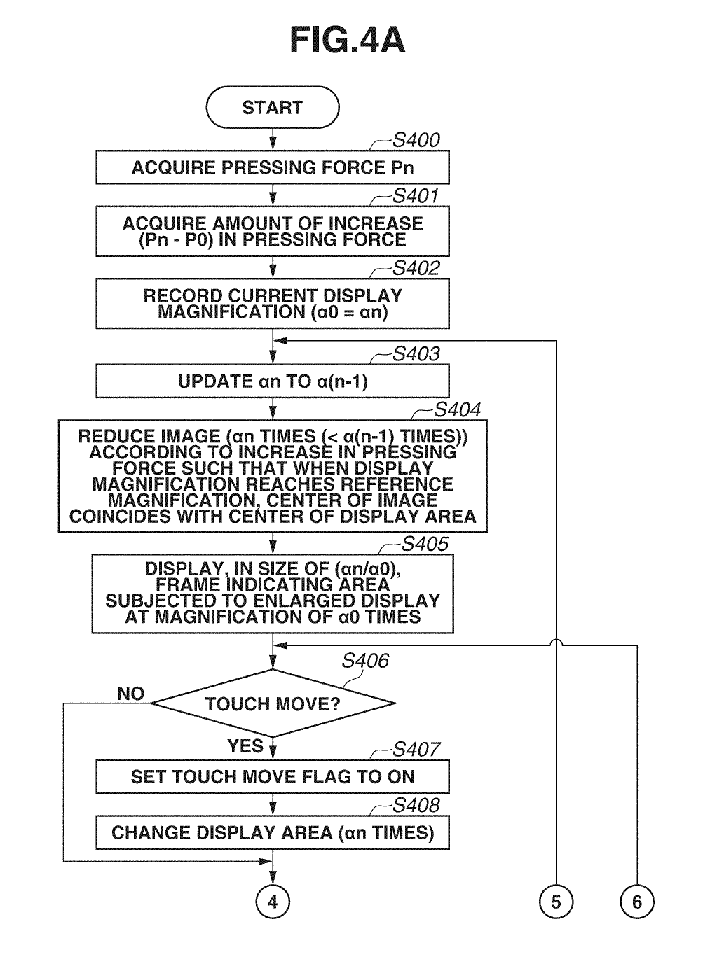

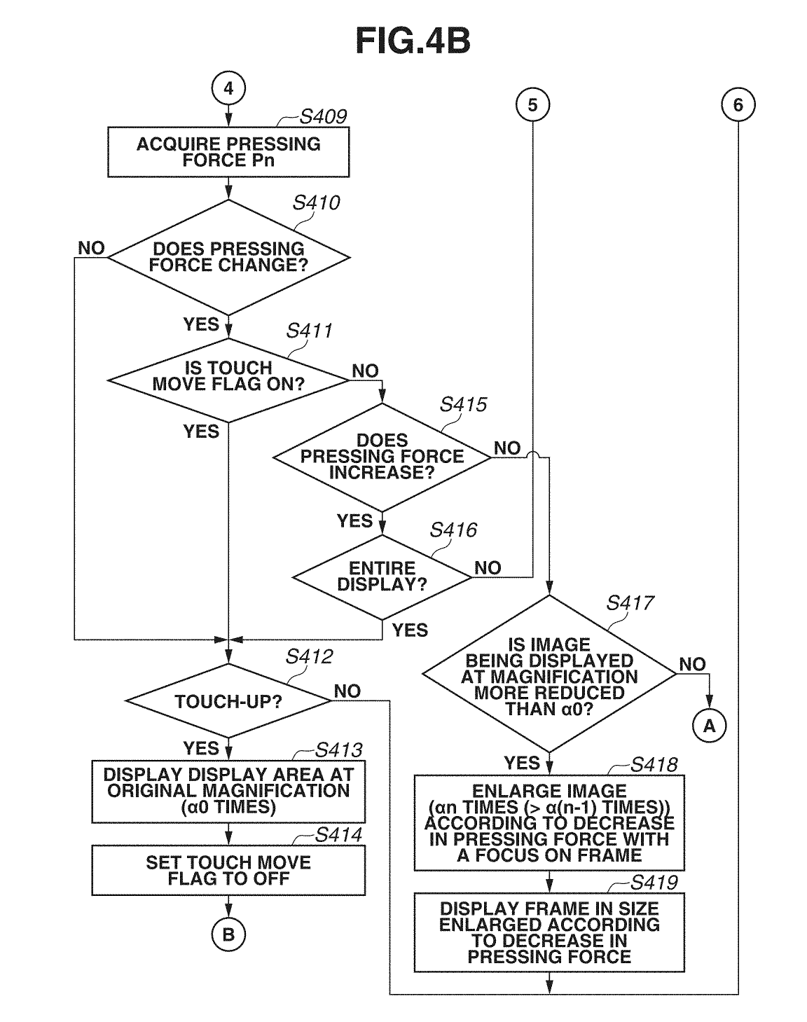

In step S306, the system control unit 50 performs a display area change process. The display area change process will be described below with reference to FIGS. 4A and 4B. In step S307, the system control unit 50 determines whether a “touch-down” is performed on the touch panel 70a. If it is determined that a “touch-down” is performed (YES in step S307), the processing proceeds to step S308. If it is not determined that a “touch-down” is performed (NO in step S307), the processing proceeds to step S310. As illustrated in FIG. 5B, in a case where the reproduction image 501 is being subjected to entire display, and if a finger Y performs a “touch-down” on the touch panel 70a (the reproduction image 501 is being subjected to entire display and is not being enlarged when a touch is started), the determination is YES in step S307. The system control unit 50 sets the position where the “touch-down” is detected as coordinates T0(X0, Y0) and sets the pressing force of the “touch-down” as P0.

In step S308, similarly to step S305, the system control unit 50 determines whether the pressing force on the touch panel 70a increases. If it is determined that the pressing force increases (YES in step S308), the processing proceeds to step S309. If it is not determined that the pressing force increases (NO in step S308), the processing proceeds to step S315. In a case where the determination in step S308 is made for the first time after the “touch-down” is detected in step S307, then similarly to step S305, if the pressing force (Pn) on the touch panel 70a becomes greater than or equal to a (kg/cm2), the system control unit 50 determines that the pressing force increases.

In a case where, after a previous determination that the pressing force increased in step S308 (YES in step S308), the processing proceeds to step S309, and the determination is made again in step S308, the system control unit 50 determines, based on the difference between the pressing force P(n−1) used in the most recent step S308 and the current pressing force Pn, whether the pressing force increases. In steps S308 and S309, if the pressing force increases, from the state of entire display, the reproduction image 501 is enlarged and displayed. If the pressing force decreases, the magnification of the reproduction image 501 is not changed (even if the pressing force decreases, the reproduction image 501 is not reduced), and the processing proceeds to the processes of step S315 and subsequent steps. In other words, if the pressing force increases in the state of entire display, the reproduction image 501 is displayed in an enlarged manner at a magnification corresponding to the maximum pressing force. Then, once the pressing force decreases, the magnification is not changed. Then, the operation of changing the display area is received until a “touch-up” is performed. After the enlarged display is performed, and if a “touch-up” is performed once, and the pressing force increases again, the determination is YES in step S303, and the determination is YES in step S305. Thus, the process of enlarging the reproduction image 501 is not performed due to the increase in the pressing force.

In step S309, the system control unit 50 enlarges and displays the reproduction image 501 at a magnification of an times with a focus on the position where the “touch-down” is performed in step S307. At this time, the magnification is increased based on the amount of increase in the pressing force as follows. If the pressing force is α≦Pn<β, the magnification is 1.1 times. If the pressing force is β≦Pn<γ, the magnification is 1.2 times. As illustrated in FIG. 5C, the reproduction image 501 is enlarged with a focus on a position Tn where the “touch-down” is performed.

In step S310, the system control unit 50 determines whether the operation of enlarging (an instruction to perform enlarged display on) the reproduction image 501 is performed. This enlargement operation can be performed by pressing the enlargement button 65 or performing a “pinch-out” operation for widening the distance between two points touched on the touch panel 70a. If it is determined that the operation of enlarging the reproduction image 501 is performed (YES in step S310), the processing proceeds to step S311. If it is not determined that the operation of enlarging the reproduction image 501 is performed (NO in step S310), the processing proceeds to step S312.

In step S311, the system control unit 50 enlarges the reproduction image 501 and sets the magnification at which the reproduction image 501 is enlarged as an. If the reproduction image 501 is enlarged by pressing the enlargement button 65, the reproduction image 501 is enlarged with a focus on the center of the reproduction image 501. If the reproduction image 501 is enlarged by performing a “pinch-out” operation, the reproduction image 501 is enlarged with a focus on the midpoint between two touched points. If the reproduction image 501 is enlarged by pressing the enlargement button 65, the magnification is changed based on the number of times the button is pressed. If the reproduction image 501 is enlarged by performing the “pinch-out” operation, the magnification is changed based on the amount of change in the distance between the two points.

In step S312, the system control unit 50 determines whether the operation of reducing (an instruction to perform reduced display on) the reproduction image 501 is performed. This reduction operation can be performed by pressing the reduction button 66 or performing a “pinch-in” operation for shortening the distance between two points touched on the touch panel 70a. If it is determined that the operation of reducing the reproduction image 501 is performed (YES in step S312), the processing proceeds to step S313. If it is not determined that the operation of reducing the reproduction image 501 is performed (NO in step S312), the processing proceeds to step S315. In a case where the display magnification of the currently displayed reproduction image 501 is that of entire display, and even if an instruction to perform reduced display is provided, the display magnification of the reproduction image 501 is not reduced.

In step S313, the system control unit 50 reduces the reproduction image 501 and sets the magnification at which the reproduction image 501 is subjected to the reduced display as an. If the reproduction image 501 is reduced by pressing the reduction button 66, the reproduction image 501 is reduced with a focus on the center of the reproduction image 501. If the reproduction image 501 is reduced by performing a “pinch-in” operation, the reproduction image 501 is reduced with a focus on the midpoint between two touched points. If the reproduction image 501 is reduced by pressing the reduction button 66, the magnification is changed based on the number of times the button is pressed. If the reproduction image 501 is reduced by performing the “pinch-in” operation, the magnification is changed based on the amount of change in the distance between the two points.

In step S314, the system control unit 50 determines whether the display magnification of the reproduction image 501 displayed on the display unit 28 is greater than the display magnification of entire display. If it is determined that the reproduction image 501 is displayed at a display magnification greater than that of entire display (YES in step S314), the processing proceeds to step S315. If it is not determined that the reproduction image 501 is displayed at a display magnification greater than that of entire display (NO in step S314), processing based on a touch operation is not performed until a “touch-up” is performed. Then, if a “touch-up” is detected, the processing proceeds to step S307.

In step S315, the system control unit 50 determines whether a “touch move” (the movement of the touch position) is performed (received) on the touch panel 70a. The system control unit 50 sets the touch position in step S304 or S307 or the touch position in the most recent step S315 as T(n−1) and sets the current touch position as Tn. If it is determined that a “touch move” is performed (YES in step S315), the processing proceeds to step S316. If it is not determined that a “touch move” is performed (NO in step S315), the processing proceeds to step S319.

In step S316, similarly to step S303, the system control unit 50 determines whether the reproduction image 501 displayed on the display unit 28 is being subjected to enlarged display. If it is determined that the reproduction image 501 is being subjected to enlarged display (YES in step S316), the processing proceeds to step S318. If it is not determined that the reproduction image 501 is being subjected to enlarged display (NO in step S316), the processing proceeds to step S317. In a case where the reproduction image 501 is not being enlarged (is being subjected to entire display), and even if a “touch move” is performed in step S315, the display area of the reproduction image 501 is not changed, and the image is switched.

In step S317, the system control unit 50 switches the image displayed on the display unit 28. If a single reproduction is performed, the preceding or following image recorded in the recording medium 200 is displayed on the display unit 28. The image is switched in a case where a “touch move” is performed by a predetermined distance or more in a horizontal direction (an X-axis direction). Even if a “touch move” other than the above is performed, the image is not switched.

In step S318, the system control unit 50 changes the display area with the magnification of the enlarged display remaining an. In other words, based on the movement of the touch position, the area to be displayed is moved in the direction of the movement. FIG. 5D illustrates the reproduction image 501 in a case where the touch position is moved from the touch position T(n−1) in FIG. 5C (to the touch position Tn), and the display range is changed. In FIG. 5D, the display area of the reproduction image 501 has a range obtained by moving by (Tn−T(n−1)) from the display area in FIG. 5C.

In step S319, the system control unit 50 determines whether a “touch-up” is performed on (the touch is released from) the touch panel 70a. If it is determined that a “touch-up” is performed (YES in step S319), the processing returns to step S302. If it is not determined that a “touch-up” is performed (NO in step S319), the processing returns to step S315. In step S315, the system control unit 50 determines whether a “touch move” is performed (whether the operation of changing the display area is performed).

According to the processing described with reference to FIGS. 3A and 3B, the user enlarges the reproduction image 501 that is being displayed on the display unit 28, or the user changes the display area, whereby the user can easily confirm a detailed portion of the reproduction image 501. If the reproduction image 501 is being subjected to entire display, the reproduction image 501 is enlarged based on an increase in the pressing force. If the reproduction image 501 is being subjected to enlarged display, the processing proceeds to the process of moving the display area illustrated in FIGS. 4A and 4B based on an increase in the pressing force. Thus, the user can easily (by an operation with a single finger Y) perform the process of enlarging the reproduction image 501 and the process of moving the display area.

In a case where the determination is NO in step S319, and none of an enlargement operation, a reduction operation, or a “touch move” is performed after the most recent “touch-down”, and if the reproduction image 501 is being enlarged, the processing returns to step S305. In step S305, the system control unit 50 determines whether the pressing force increases. If the pressing force increases, the process of step S306 is performed. In a case where none of an enlargement operation, a reduction operation, or a “touch move” is performed, and if the reproduction image 501 is being subjected to entire display, the processing returns to step S308.

A display area change process according to the present exemplary embodiment is described with reference to the flowcharts of FIGS. 4A and 4B. This processing is achieved by loading a program recorded in the non-volatile memory 56 into the system memory 52 and by the system control unit 50 executing the program. This processing is started if the determination is YES in step S305 in FIG. 3A.

In step S400, the system control unit 50 acquires the pressing force Pn after the pressing force increases in step S305 in FIG. 3A. Then, the system control unit 50 records the pressing force Pn in the system memory 52. In step S401, the system control unit 50 acquires the amount of increase ΔPn=(Pn−P0) in the pressing force from the pressing force P0 recorded in the system memory 52 in step S304 in FIG. 3A and the pressing force Pn recorded in step S400.

In step S402, the system control unit 50 records, as the magnification before reduction in the system memory 52, the display magnification of the reproduction image 501 currently displayed on the display unit 28. As a current display magnification α0 (the display magnification before reduction), the value of the magnification (αn) acquired in the process performed most recently in any one of step S309 in FIG. 3A or steps S311 and S313 in FIG. 3B is set. FIG. 6A illustrates the state where a “touch-down” is performed in step S304 in FIG. 3A. The system control unit 50 sets the touch position where the “touch-down” is performed as T0(X0, Y0) and sets the pressing force of the “touch-down” as P0. The system control unit 50 sets the display magnification of the reproduction image 501 illustrated in FIG. 6A when the “touch-down” is performed in step S304 (when the image is enlarged) as α0.

In step S403, the system control unit 50 updates the display magnification αn set in step S402 or the previous step S403 to a display magnification α(n−1). This is to set the display magnification when the image is reduced in step S404 as an. In step S404, the system control unit 50 reduces and displays the reproduction image 501 based on the amount of increase in the pressing force acquired in step S401. The reproduction image 501 can be reduced with a focus on the center position of the reproduction image 501 or the touch position. At this time, the position of the reproduction image 501 is adjusted so that the ends of the reproduction image 501 are not located inside the ends of the display area.

When the display magnification of the reproduction image 501 reaches the display magnification of entire display (1 time), a center point C of the reproduction image 501 coincides with the center of the display area of the display unit 28. The system control unit 50 updates the display magnification αn to the magnification at which the reproduction image 501 is subjected to the reduced display in step S404. Then, the system control unit 50 records the updated magnification in the system memory 52. The system control unit 50 sets the magnification of the display before the reproduction image 501 is subjected to the reduced display in step S404 as α(n−1).

The reproduction image 501 is displayed in such a manner that the more the pressing force increases, the more reduced the reproduction image 501 is. For example, if the amount of increase ΔPn in the pressing force is α≦ΔPn<β, the reproduction image 501 is reduced from the magnification α0 or α(n−1) to 0.9 times. If the amount of increase ΔPn in the pressing force is β≦ΔPn<γ, the reproduction image 501 is reduced from the magnification α0 or α(n−1) to 0.7 times. The reproduction image 501 is reduced with a focus not on the center point of the display area enlarged and display on the display unit 28, but on the center point C of the reproduction image 501 so that, when the reproduction image 501 is reduced by 1 times, the center of the display unit 28 coincides with the center point C of the image. This makes it easier for the user to view the entirety of the reproduction image 501 as reduced. FIG. 6B illustrates the reproduction image 501 displayed on the display unit 28 in a case where the pressing force is Pn. At this time, the reproduction image 501 is displayed at the display magnification αn, which is less than a display magnification of α0 times in FIG. 6A before the reduction or than the most recent display magnification α(n−1) (the value recorded as the display magnification before the reduction in the most recent step S404). If the pressing force increases in the state where a “touch move” is not performed, the reproduction image 501 is displayed at a smaller display magnification and reduced to the display magnification of entire display as illustrated in FIG. 6C.

In step S405, the system control unit 50 displays a frame 601 (a mark or a sign), which indicates the area displayed in step S402 before the reproduction image 501 is reduced and displayed (the display area when the “touch-down” is performed in step S304 in FIG. 3A). At this time, the frame 601 indicates the range of the reproduction image 501 displayed at a magnification of α0 times in FIG. 6A. Thus, the frame 601 is displayed in a size of (αn/α0) of the display area of the reproduction image 501 on the display unit 28.

In step S406, the system control unit 50 determines whether a “touch move” (the movement of the touch position) is performed on the touch panel 70a. If it is determined that a “touch move” is performed (YES in step S406), the processing proceeds to step S407. If it is not determined that a “touch move” is performed (NO in step S406), the processing proceeds to step S409.

In step S407, the system control unit 50 sets a “touch move” flag to “on” and records the set “touch move” flag in the system memory 52. The “touch move” flag is a flag indicating whether the user performs a “touch move”. In the present exemplary embodiment, the “touch move” flag is a flag indicating whether a “touch move” is performed to change the range of the reproduction image 501 displayed in the frame 601 (or on the display unit 28). If the “touch move” flag is on, it is indicated that a “touch move” is performed. In other words, the “touch move” flag is a flag for determining whether a scroll instruction, an instruction to change the display range, or an instruction to change the range subjected to enlarged display is provided by a “touch move”.

In a case where the touch position is moving, the detected pressing force is likely to change. Thus, the “touch move” flag is used to prevent the display magnification of the reproduction image 501 from changing based on a change in the pressing force due to the movement of the touch position. If the reproduction image 501 moves while the display magnification changes, it is difficult to understand which area is to be displayed at which magnification. This reduces the visibility for the user. If an area moved by the user moving the touch position changes, and even if the user thinks that a desired area is displayed, the magnification can change, and the desired area can be shifted. In response, the “touch move” flag is set to “on” so that the display magnification is not changed while a “touch move” is performed. Thus, it is possible to change the display area with the display magnification remaining constant (it is possible to prevent the magnification from changing). Even if the “touch move” flag is on, a change in the display magnification is received through an operation on the enlargement button 65 or the reduction button 66. If an instruction to change the magnification is provided by an operation on an operation member provided separately from the touch panel 70a, it is likely that the user is attempting to change the display magnification even while the display range is being changed. Thus, the display magnification is changed.

In step S408, similarly to step S318 in FIG. 3B, the system control unit 50 changes the display area with the display magnification during the enlargement remaining an. FIG. 6C illustrates the state of the reproduction image 501 subjected to entire display before the movement of the touch position is detected in step S406. FIG. 6D illustrates the state of the reproduction image 501 after the display area is changed. In FIGS. 6C and 6D, while the display position of the frame 601 is not changed, the display position of the reproduction image 501 is changed, and the range of the reproduction image 501 displayed within the frame 601 is changed.

In FIG. 6C, the frame 601, which indicates the range subjected to the enlarged display in FIG. 6A, is displayed at coordinates Sn (indicate the position of the upper left corner of the frame 601 and also the position of the frame 601). In FIG. 6C, a center point of the reproduction image 501 is at the center of the display area of the display unit 28. Thus, the coordinates Cn of the center point are set as C0. If a “touch move” is performed, the reproduction image 501 moves as in the reproduction image 501 illustrated in FIG. 6D. Thus, if the “touch move” moves by ΔTn=(Tn−T(n−1)), the position of the coordinates Cn of the center point also moves and the coordinates Cn of the center point are represented as Cn=ΔTn+C0.

As described above, after the reproduction image 501 is reduced, and a wider area is displayed, the user can search for a desired area on which the user wishes to perform enlarged display. The user scrolls the reproduction image 501 by a “touch move” operation so that an area on which the user wishes to perform enlarged display is located within the frame 601, whereby the user can easily select a desired area. At this time, as illustrated in FIG. 6D, the ends (the right and lower ends) of the reproduction image 501 do not stop at the ends (the right and lower ends) of the display area of the display unit 28 and can move further in an outward direction (the right direction or the down direction). Thus, the range the reproduction image 501 can be moved into the frame 601 is not limited. If the ends (the left and upper ends) of the reproduction image 501 move past the ends (the left and upper ends) of the display unit 28 and further in an inward direction, an area where the reproduction image 501 is not displayed is displayed as a black area. As described above, a black area (an area where the reproduction image 501 is not displayed) is provided, and the range of movement of the reproduction image 501 is made wider, whereby it is possible to display any area in the reproduction image 501 in the frame 601 of which the display position is determined. In other words, it is possible to move the display position of the entirety of the reproduction image 501 to display within the frame 601 an area included in the reproduction image 501 and desired by the user.

In step S409, the system control unit 50 acquires the current pressing force Pn, records the current pressing force Pn in the system memory 52, and also records, as the most recent pressing force P(n−1) in the system memory 52, the pressing force Pn acquired in step S400 or the most recent step S409. In step S410, the system control unit 50 compares the pressing forces Pn and P(n−1) recorded in the system memory 52 in step S409, thereby determining whether the pressing force has changed. If it is determined that the pressing force has changed (YES in step S410), the processing proceeds to step S411. If it is not determined that the pressing force has changed (NO in step S410), the processing proceeds to step S412.

In step S411, the system control unit 50 determines whether a “touch move” is detected in step S406, and the “touch move” flag is set to “on”. Even if the pressing force changes, but the “touch move” flag is “on”, the display magnification of the reproduction image 501 is not changed based on the change in the pressing force. Thus, the processing does not proceed to steps S415 to S419, in which the process of changing the display magnification is performed. If the “touch move” flag is “on”, the process of changing back the display magnification to the magnification before the reduction in steps S412 to S414 or the process of further changing the display range is received. If the “touch move” flag is set to on (YES in step S411), the processing proceeds to step S412. If the touch move flag is not set to on (NO in step S411), the processing proceeds to step S415.

In step S412, the system control unit 50 determines whether the operation of releasing the touch (a “touch-up”) from the display unit 28 (the touch panel 70a) is performed. If it is determined that the operation of releasing the touch is detected (YES in step S412), the processing proceeds to step S413. If it is not determined that the operation of releasing the touch is detected (NO in step S412), the processing returns to step S406. In step S406, the system control unit 50 determines whether a “touch move” is performed.

In step S413, the system control unit 50 displays the area (a specified area) indicated by the frame 601 and included in the reproduction image 501 at the display magnification α0, which is the display magnification before the reduced display in step S404 and is recorded in the system memory 52 in step S402. FIG. 6E illustrates an example of display of the reproduction image 501 in step S413. The area within the frame 601 illustrated in FIG. 6D is displayed in an enlarged manner on the display unit 28. In other words, the area in the reproduction image 501 included within the frame 601 is displayed by a “touch-up” operation at the magnification at which the reproduction image 501 is originally displayed (α0 times in FIG. 6A).

As described above, based on the operation of releasing a touch, a specified area is displayed at a display magnification before a “touch-down” is performed (before a press is performed). Thus, it is possible to reduce an image subjected to enlarged display, specify an area to be subjected to enlarged display, and then smoothly perform enlarged display on the specified area. In other words, the user can easily change an area to be subjected to enlarged display by performing a series of operations including a “touch-down”, a press, a “touch move”, and a “touch-up”. More specifically, if the user performs a “touch-down” on a reproduction image that is being subjected to enlarged display, and the user presses the reproduction image, the reproduction image is subjected to reduced display. Thus, the user can easily select a desired area by a “touch move” (move the reproduction image 501 to fall within the frame 601).

If the user performs a “touch-up”, the user can change back the display magnification. The user reduces the reproduction image once and thereby can easily search for the desired area even if the user cannot understand where the desired area is relative to the area that is currently being enlarged. Thus, the user does not need to perform a “touch move” many times in various directions to search for the desired area. The user only needs to search for the desired area in the reduced image and perform a “touch move” from the currently selected area to the desired area. At this time, the reduction of the image also shortens the moving distance of the “touch move” from the currently selected area to the desired area. In other words, it is possible to quickly display the selected area at the same display magnification as that of the area where the image is originally subjected to enlarged display. Thus, it is possible to change the enlarged area easily and with a small amount of operation. It is possible to select the desired area by a “touch move” operation and enlarge the desired area by the operation of releasing the touch. Thus, it is possible to select and enlarge an area by a series of operations.

For example, in a known case where the display range of the reproduction image 501 is changed from the state where the eyes of a person G are displayed in FIG. 6A to the state where the right eye of a person B is displayed in FIG. 6E, and if the reproduction image 501 remains enlarged, the distance of the touch move is long. More specifically, if the display magnification is α0 times, it is necessary to move by a distance α0 times the moving distance in the case of entire display. The user needs to perform a “touch-down” on the left end of the display unit 28 and perform a “touch move” to approximately the right end of the display unit 28, i.e., until the face of the person G is not displayed from the state of FIG. 6A, and the right eye of the person B is displayed. In a case where the user does not perform a “touch-down” on the left end of the display unit 28 and start a “touch move”, the user needs to perform a “touch-down”, a “touch move”, and a “touch-up” multiple times. If, the user performs a “flick” operation from the person G in the reproduction image 501 in the left direction, in which the person B is located, the reproduction image 501 moves until the left end of the display unit 28 coincides with the left end of the reproduction image 501. Thus, the reproduction image 501 goes past an area desired by the user. After the reproduction image 501 goes past the desired area, the user needs to perform the operation of adjusting to the desired area.

In the present exemplary embodiment, the reproduction image 501 is reduced as in FIG. 6C. Thus, the moving distance becomes short in proportion to the magnification at which the reproduction image 501 is reduced. Thus, it is only necessary to move by approximately half the width of the display unit 28, which is the moving distance of the reproduction image 501 illustrated in FIGS. 6C to 6D. It is not necessary to perform operations many times to the desired area, and it is possible to accurately adjust to the desired area at one time by viewing the frame 601.

In step S414, the system control unit 50 sets the “touch move” flag to off and records the set “touch move” flag in the system memory 52. Then, the processing proceeds to step S302 in FIG. 3A. In step S415, the system control unit 50 determines whether the change in the pressing force determined in step S410 is an increase (whether the pressing force increases or decreases). If it is determined that the pressing force increases (YES in step S415), the processing proceeds to step S416. If it is not determined that the pressing force increases (the pressing force decreases) (NO in step S415), the processing proceeds to step S417.

In step S416, the system control unit 50 determines whether the reproduction image 501 currently displayed on the display unit 28 is being subjected to entire display (displayed at the magnification at which the reproduction image 501 is displayed in step S301 in FIG. 3A). More specifically, the system control unit 50 determines whether the reproduction image 501 is reduced from the display magnification at which the reproduction image 501 is enlarged as illustrated in FIG. 6A or 6B to the display magnification at which the reproduction image 501 is subjected to entire display as illustrated in FIG. 6C. If it is determined that the reproduction image 501 is being subjected to entire display (YES in step S416), the processing proceeds to step S412. If it is not determined that the reproduction image 501 is being subjected to entire display (NO in step S416), the processing proceeds to step S403. If the reproduction image 501 is being subjected to entire display, if the pressing force increases, the reproduction image 501 is not subjected to reduced display any further. Thus, the processing proceeds to the processes of steps S412 to S414. If, the reproduction image 501 is not being subjected to entire display (is being subjected to enlarged display), then to perform reduced display, the processing proceeds to step S403. In step S403, the reproduction image 501 is subjected to reduced display at a magnification based on the increase in the pressing force.

In step S417, the system control unit 50 determines whether the display magnification of the reproduction image 501 currently displayed on the display unit 28 is a magnification more reduced than the display magnification α0 recorded in the system memory 52 in step S402. Since it is determined in step S415 that the pressing force decreases, the display magnification is more enlarged than before it is determined in step S410 that the pressing force changes. The user, however, is attempting to search for a desired area by reducing the reproduction image 501 subjected to enlarged display in step S402. Thus, the reproduction image 501 is not subjected to enlarged display by being more enlarged than the display magnification in step S402, i.e., the display magnification before the “touch-down”. More specifically, if the display magnification is a magnification more reduced than (a display magnification smaller than) the display magnification α0 (YES in step S417), the processing proceeds to steps S418 and S419. In steps S418 and S419, the reproduction image 501 is subjected to enlarged display based on the decrease in the pressing force. If the display magnification is not a magnification more reduced than (a display magnification smaller than) the display magnification α0 (the reproduction image 501 is being displayed at the display magnification α0) (NO in step S417), the processing returns to step S305 in FIG. 3A. If the processing returns to step S305, the display magnification is the same as that before the “touch-down”. Thus, even if the “touch move” flag is on, the display area is changed based on the subsequent “touch move” (the determination is YES in step S315, and the processing proceeds to step S318).

In step S418, the system control unit 50 enlarges the reproduction image 501, based on the decrease in the pressing force, with a focus on the frame 601. Then, the system control unit 50 sets the display magnification after the enlargement as αn, sets the most recent display magnification as α(n−1), and records the display magnifications αn and α(n−1) in the system memory 52. As described above, if a “touch-down” is performed in the state where the reproduction image 501 is subjected to enlarged display, the system control unit 50 changes the display magnification of the reproduction image 501 to a magnification based on the pressing force in such a manner that the upper limit is the magnification before the “touch-down”, and the lower limit is the magnification of normal display.

In step S419, the system control unit 50 displays the frame 601 in a size enlarged based on the decrease in the pressing force. More specifically, the frame 601 is displayed by being enlarged from (α(n−1)/α0) times the display area of the reproduction image 501 on the display unit 28 to (αn/α0) times.

According to the above exemplary embodiment, after an image is subjected to reduced display based on an increase in a pressing force, and when an area to be subjected to enlarged display is further selected by a “touch move”, and even if there is a change in the pressing force, the display magnification is not changed. This makes it easy for the user to select a desired area. If the display magnification of a reproduction image is changed based on a change in a pressing force, and subsequently, the user performs a “touch move” to change a display area, an unintended change in the pressing force is likely to occur. Thus, there is a possibility that the display magnification changes against the user's intention. As in the above exemplary embodiment, however, if a “touch move” is performed, a “touch move” flag is set to on (step S407). Then, even if there is a change in the pressing force, the display magnification is not changed (YES in step S411). More specifically, in a case where a first function (e.g., a change in the display magnification) based on a change in the pressing force on a touch panel is executed, and if a “touch move” is being performed, and even if there is a change in the pressing force, the first function is not executed. Thus, it is possible to achieve the effect that the first function is less likely to be unintentionally executed. In other words, since the user is performing the “touch move” to execute a second function (e.g., the scrolling of an image or the movement of a frame) performed based on a “touch move”, the first function is not performed, thereby reducing the possibility that an unintended function is executed.

After the display magnification of an image is changed based on a change in the pressing force of a touch (step S404), and if the press state is canceled (a touch-up is performed in step S412), the image is displayed at the original display magnification. Thus, after the image is displayed at a different display magnification based on the change in the pressing force, the display magnification is changed back by the operation of releasing the touch to the display magnification before the pressing force is applied (before the operation causing the change in the display magnification is performed). Thus, the user can display the image at a desired magnification without performing the operation of changing back the display magnification to the original display magnification.

It is possible, by an intuitive operation such as an increase in a pressing force, to change the display magnification in different directions based on whether the reproduction image 501 is subjected to entire display or enlarged display. More specifically, when the reproduction image 501 is being subjected to entire display (NO in step S303 in FIG. 3A), and if a pressing force is applied, the reproduction image 501 is subjected to enlarged display. When the reproduction image 501 is being subjected to enlarged display (YES in step S303 in FIG. 3A), and if a pressing force is applied, the reproduction image 501 is subjected to reduced display. As described above, if a displayed image is already enlarged (enlarged relative to entire display), it is likely that the user is attempting to reduce the displayed image. Thus, it is more intuitive to reduce the displayed image based on the operation of increasing the pressing force. If a displayed image is subjected to entire display (at a magnification as a reference for the display magnification, namely a display magnification of 1 time), it is likely that the user is attempting to enlarge the displayed image. Thus, it is more intuitive to enlarge the displayed image based on the operation of increasing the pressing force than to reduce the displayed image. In the above exemplary embodiment, a case has been described where the display magnification is changed based on the pressing force. Alternatively, the display magnification can be changed based on, instead of the pressing force, an operation other than a touch operation, such as a button operation or a dial operation.

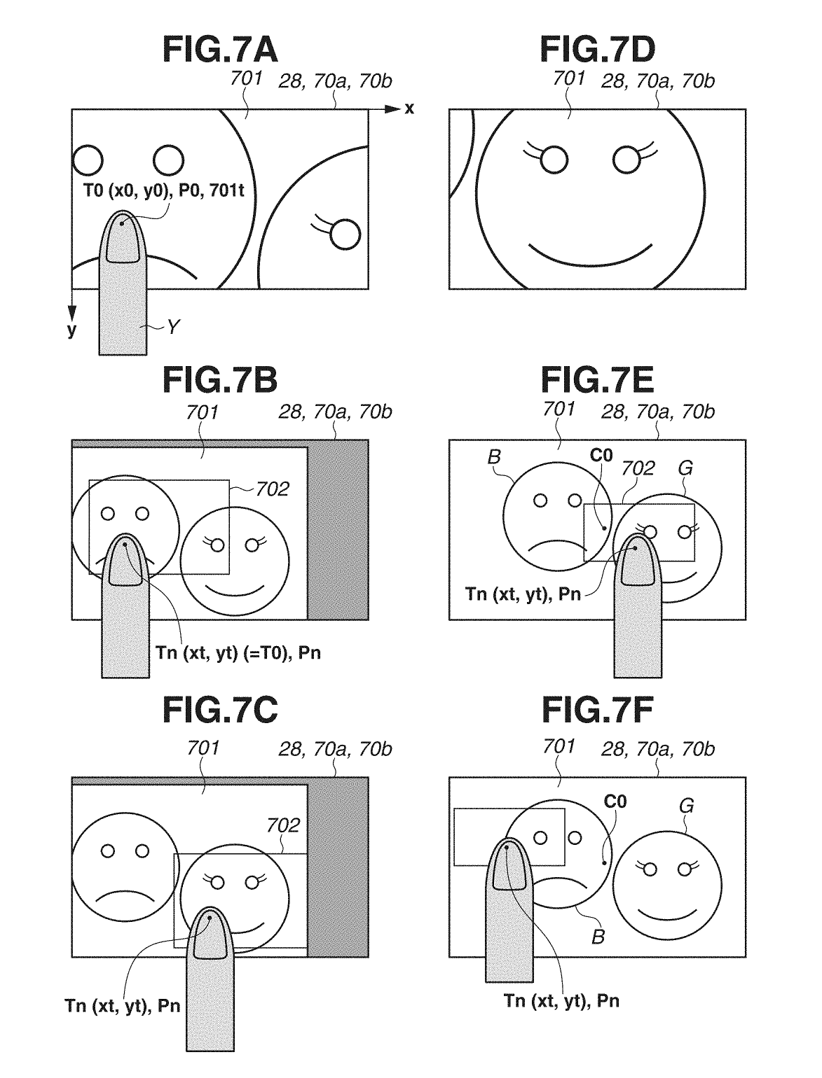

Next, a second exemplary embodiment will be described with reference to FIGS. 7A to 7D. In the second exemplary embodiment, the configuration of the digital camera 100 is similar to that in FIGS. 1 and 2 described in the first exemplary embodiment, and the processing in FIGS. 3A and 3B and FIGS. 4A and 4B is also similar to that in the first exemplary embodiment except for the configuration described below. This processing is achieved by loading a program recorded in the non-volatile memory 56 into the system memory 52 and by the system control unit 50 executing the program.

In the exemplary embodiment described with reference to FIGS. 4A and 4B and FIGS. 5A, 5B, 5C, and 5D, a case has been described where, when the reproduction image 501 is reduced in step S404 in FIG. 4A, the position of the reproduction image 501 is adjusted so that the ends of the reproduction image 501 are not located inside the ends of the display area. In the second exemplary embodiment, however, the reproduction image 501 is reduced with a focus on the touch position, and even if the ends of the reproduction image 501 are located inside the ends of the display area by reduction, the position of the reproduction image 501 is not corrected. In other words, when the reproduction image 501 is reduced to the display magnification of entire display, the center of the reproduction image 501 may not coincide with the center of the display area, and the display area can include an area where the reproduction image 501 is not displayed.

FIG. 7A illustrates the states of, when a “touch-down” is performed on the touch panel 70a in step S304 in FIG. 3A, a reproduction image 701 and the “touch-down”. The display magnification of the reproduction image 701 at this time is set as α0. FIG. 7B illustrates the state where based on the pressing force increasing (YES in step S305 in FIG. 3A, or YES in step S415 and NO in step S416 in FIG. 4B), the reproduction image 701 is displayed (subjected to reduced display) at a display magnification smaller than α0, and the display magnification is an. At this time, in the second exemplary embodiment, as described above, the display position of the reproduction image 701 is not corrected. Thus, if the reproduction image 701 continues to be reduced, there will be an area where the reproduction image 701 is not displayed. The reproduction image 701 is reduced with a focus on a touch position 701t, and the position of the reproduction image 701 is not adjusted. Thus, if the touch position is not moved, then as illustrated in FIG. 7B, a frame 702 is displayed at the touch position. In the first exemplary embodiment, the description was provided based on the assumption that the reproduction image 501 moves based on a “touch move” after reduction.

In the second exemplary embodiment, however, the frame 702 moves based on the movement of the touch position after reduction. If a “touch move” is performed in the state where the frame 702 is touched in FIG. 7B, the frame 702 moves and is displayed at a position illustrated in FIG. 7C. At this time, if a “touch-up” is performed (YES in step S412), then as illustrated in the reproduction image 701 in FIG. 7D, an area included within the frame 702 in FIG. 7C is displayed by being enlarged to a display magnification of α0 times, which is the display magnification of the reproduction image 701 in FIG. 7A. If the frame 702 reaches the end (e.g., the left end) of the display unit 28, the reproduction image 701 is moved (in the right direction) inside the display unit 28. Then, an area that is not displayed when the reproduction image 701 is reduced is displayed within the display unit 28 so that the area can be included within the frame 702. In the second exemplary embodiment, similarly to the first exemplary embodiment, if a “touch move” is detected, a “touch move” flag is set to on (step S407). Then, even if the pressing force changes, the display magnification does not change.

According the above exemplary embodiment, after an image is subjected to reduced display based on an increase in a pressing force, and when an area to be subjected to enlarged display is further determined by a “touch move”, and even if there is a change in the pressing force, the display magnification is not changed. This makes it easy for the user to select a desired area.

In the case of the first exemplary embodiment, a frame can be moved based on a “touch move” after reduction. FIGS. 7E and 7F are diagrams illustrating the state where an area to be subjected to enlarged display is selected by moving a frame in the state of entire display in the first exemplary embodiment. FIG. 7E is a diagram illustrating the state where the display magnification of the reproduction image 701 is reduced from α0 times to the display magnification of entire display by a press, and the frame 702 is displayed at the touch position. FIG. 7F is a diagram illustrating the state after the frame 702 is moved by a “touch move”. In the second exemplary embodiment, as illustrated in FIG. 7F, the frame 702 moves based on a “touch move”, but the reproduction image 701 does not move. If a “touch-up” is performed in the state of FIG. 7F (YES in step S412), then as illustrated in FIG. 6E, a right eye portion of the person B is enlarged. In the second exemplary embodiment, similarly to the above exemplary embodiment, if a “touch move” is detected, a “touch move” flag is set to on (step S407). Then, even if the pressing force changes, the display magnification does not change.

In the above exemplary embodiments, the state of the reproduction image 501 when a “touch move” is performed in step S406 has been described using the diagram in FIG. 6C, which illustrates a case where the reproduction image 501 is subjected to entire display. Alternatively, even if the reproduction image 501 is not subjected to entire display and is displayed at a magnification different from that in FIG. 6C, a “touch move” is received in step S406 so long as the frame is being displayed.

In the above exemplary embodiments, the reproduction image 501 is subjected to reduced display after enlarged display. Then, if the display magnification is reduced to the magnification of entire display as a reference, the reproduction image 501 is not subjected to reduced display any further (the determination is YES in step S416, and the processing does not proceed to step S404). Alternatively, the reproduction image 501 can be reduced more than the magnification of entire display.

If the “touch move” flag is set to “on”, a change in the pressing force on the press detection unit 70b may not be detected, or the output value of the pressing force on the press detection unit 70b may not be acquired. Then, the touch panel 70a can detect a “touch-up” in step S412 and a “touch move” in step S406. Alternatively, even if the “touch move” flag is “on”, the pressing force can be acquired. Then, if the acquired pressing force becomes less than a predetermined magnitude, and even if a “touch-up” is not performed, the determination can be YES in step S412.

Regarding a change in the pressing force, if there is a change greater than or equal to a predetermined magnitude, it can be determined that the pressing force decreases or increases. In the above exemplary embodiment, a case has been described where, if the “touch move” flag is “on”, the display magnification is not changed based on a change in the pressing force. Alternatively, the display magnification may not be changed based on a change in the pressing force within a predetermined range. More specifically, if not a change in the pressing force that changes based on a “touch move”, but a great change in the pressing force considered to be caused by the user intentionally increasing the pressing force occurs, the display magnification of the image can be changed. Alternatively, if the “touch move” flag is on, the display magnification of the image may not be changed based on a change corresponding to a decrease in the pressing force. If the pressing force increases, the display magnification of the image can be changed. Based on the movement of the touch position (a “touch move”), it is likely that the pressing force becomes smaller to move the touch position from the position of the press. Thus, if the pressing force increases, it is likely that the user intentionally attempts to change the display magnification. Thus, if only a change in the display magnification based on a change corresponding to a decrease in the pressing force is inhibited, it is possible to prevent the display magnification from changing based on an unintended change in the pressing force due to the movement of the touch position, and also change the display magnification (perform reduced display).

In the above exemplary embodiments, a case has been described where, if a “touch-up” is performed in step S412, the image is displayed by changing back the display magnification of the image to the original magnification (a display magnification of α0 times in step S402). Alternatively, after a “touch-up” is performed, and also after the lapse of a predetermined time, the image can be displayed at the original magnification. Thus, if the user wishes to confirm a selected position while an image remains reduced, and reselect an area to be enlarged anew, the user can reselect the area to be enlarged within a predetermined time.

In the above exemplary embodiments, the description has been provided on the assumption that a display target to be displayed on the display unit 28 is a reproduction image. The exemplary embodiments, however, are not limited to this. Alternatively, a map, text, a captured image (a live view image or a through image), a web page, a document in which a map and text are mixed, or a table can be displayed on the display unit 28. For example, in a case where a map is displayed, to confirm a part around a destination or a displayed area, the display magnification is made smaller (so that a wider range becomes viewable) based on an increase in the pressing force. After the map is reduced, and if the user finds that a town that the user searches for is not included in a currently displayed district, the user can search for a district including the desired town by a “touch move”. At this time, if the display magnification is changed based on a change in the pressing force during the “touch move” in such a manner that the map is displayed at a great magnification for representing streets or buildings in detail, or the map is displayed at a small magnification for representing prefectures or countries, it is difficult to search for a place on a district-by-district basis. If the user performs a “touch move” while the map is being displayed at a magnification for representing countries, the display range can, for example, move from Asia to Europe. If the user performs a “touch move” while the map is being displayed at a magnification for representing buildings, roads can merely switch, and the user may not reach the desired district. Thus, if the user performs a “touch move”, and even if there is a change in the pressing force, the display magnification is not changed, whereby it is possible to maintain a magnification for representing districts. This enables the user to easily search for the desired district.

In a case where the entire range that can be displayed, such as a map or text, cannot be displayed within the display area of the display unit 28, or in a case where the entire range is subjected to reduced display by being too reduced, and the display content can no longer be confirmed, the display range can be changed by a “touch move” operation, regardless of the display magnification. More specifically, the image may not be switched even at the magnification of entire display, and unlike the case of the above reproduction image, the display range can always be changed by a “touch move” operation.

In the above exemplary embodiments, a reproduction image has been described. The present exemplary embodiments, however, are also applicable to a case where a captured image is displayed. When a captured image is displayed, unlike when an image is reproduced, if the entire image can be viewed immediately before the image is captured, it is easier to determine whether the image should be captured in the current image capturing range. In response, if the user provides an image capturing preparation instruction while an image is being subjected to enlarged display, the image is changed back to entire display. This enables the user to confirm the details of the image, then confirm the entire image immediately before capturing the image, and give an image capturing instruction. Even if an image capturing preparation instruction is given, the display magnification may not be changed until an AF process ends. Then, if an image capturing instruction is provided, the display magnification can be changed back to that of entire display. Alternatively, after an AF process ends, and also after the lapse of a predetermined time, the display magnification can be changed back to that of entire display.

Based on the “touch-up” in step S412, instead of being displayed at the display magnification at which the reproduction image 501 is originally displayed (step S402), the reproduction image 501 can be displayed at a magnification greater than an, such as a magnification of 2 times or 3 times the magnification αn before the “touch-up” is performed.

In the above exemplary embodiments, in step S416, it is determined whether the currently displayed image is being subjected to entire display. Alternatively, it can be determined whether the currently displayed image is reduced to a predetermined magnification smaller than that of entire display. Depending on the position where the movement of the “touch move” is started, the distance by which the image can move is limited. Thus, the area that can be included within the frame is limited. In response, if the image is reduced to a size such as half or one third of entire display, it is possible to increase the area that can be moved into the frame, regardless of the start position of the “touch move”.

The above description has been provided taking as examples a change in the magnification when an image is displayed and a change in the display area. The processing described in the above exemplary embodiments, however, is not limited to this, and is also applicable to a case where a function other than a change in the magnification is executed based on the pressing force becoming greater than or equal to a predetermined magnitude, and a case where a function other than a change in the display area is executed based on the movement of the touch position. As a function executed based on a pressing force greater than or equal to the predetermined magnitude being applied, for example, the function of determining a selected item or a selected image, the function of displaying a screen for making advanced settings regarding a predetermined item, a simple display function for a selected image or selected text, or the function of returning to a predetermined screen is applicable. More specifically, the function of displaying a selected display target on the display unit 28, or the function of determining a selected item can be assigned. As a function executed based on the movement of the touch position, a function for the operation of changing a setting value displayed on a bar (changing a parameter), or a function for the operation of moving an item is applicable.

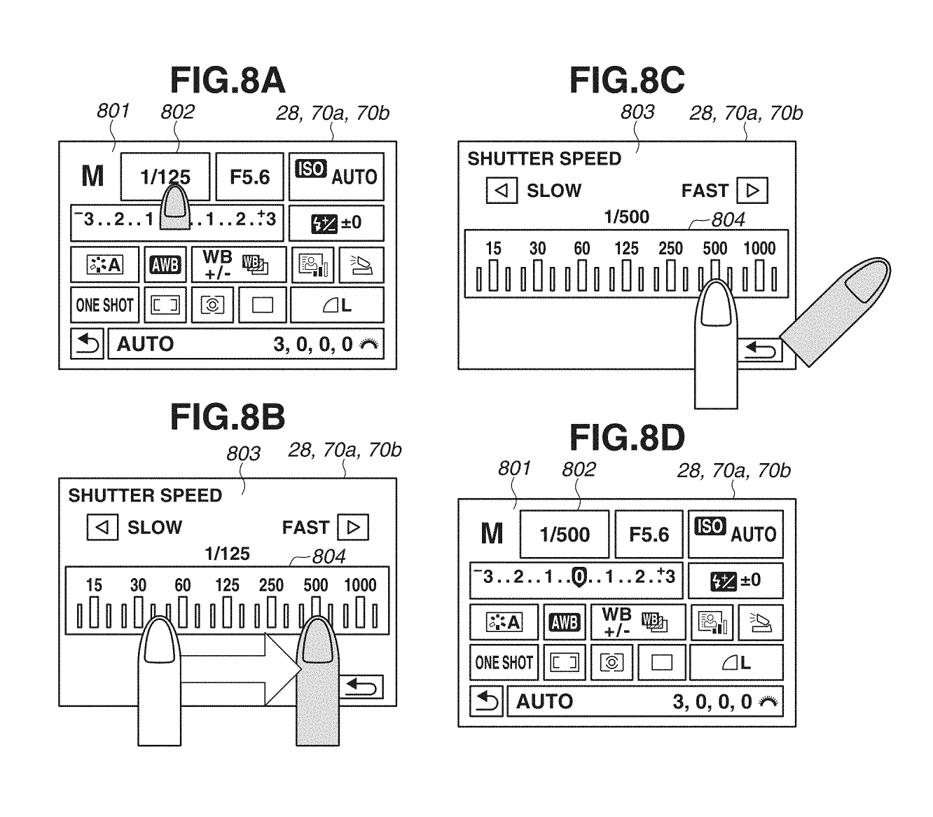

FIGS. 8A to 8D illustrate examples of setting screens to which the present exemplary embodiments are applicable. If a “touch move” is performed without applying a pressing force, the operation of selecting an item is performed. If a pressing force greater than or equal to a predetermined magnitude is applied, the operation of determining the item is performed. If a “touch move” is performed after that, the operation of changing a setting value is performed. FIG. 8A illustrates an item list screen 801 (a first screen), which enables selection of an item of which the setting is to be changed. If a pressing force greater than or equal to the predetermined magnitude is applied on an icon surrounded by a thick frame, an item corresponding to the icon at the touch position can be selected.

As illustrated in FIG. 8A, if a pressing force greater than or equal to the predetermined magnitude is applied on an icon 802, the item of the shutter speed corresponding to the icon 802 is selected. Then, the item list screen 801 transitions to a setting screen 803 for the shutter speed (a second screen at a lower hierarchical level than the first screen) illustrated in FIG. 8B. If the user performs a “touch move” on a bar 804 on the setting screen 803, the user can change the setting value of the shutter speed. After the item list screen 801 transitions to the setting screen 803, and if the pressing force weakens in the state where a “touch move” is not performed, and the pressing force becomes less than a threshold, the setting screen 803 returns to the item list screen 801 illustrated in FIG. 8A. Then, if the user performs a “touch move” without releasing the touch, the user can select an item different from the shutter speed.

If the user applies a pressing force greater than or equal to the predetermined magnitude, it is possible to transition to a setting screen for the selected item. Then, after the item list screen 801 transitions to the setting screen 803 for the shutter speed, and if a “touch move” is started, and the “touch move” flag is set to “on”, the setting screen 803 does not return to the item list screen 801 even if the pressing force becomes less than the threshold. For example, as illustrated in FIG. 8B, in a case where the shutter speed is set to 1/125, and if the touch position is moved to the position of “500” in a scale on the bar 804, then as illustrated in FIG. 8C, 1/500 is selected as the shutter speed. At this time, even if the user weakens the pressing force of the touch without performing a “touch-up”, the setting screen 803 does not transition to the item list screen 801. If the user performs a “touch move”, the user can change the shutter speed. As illustrated in FIG. 8C, if the touch is released from the position of “500” in the scale, the shutter speed is changed (set) to 1/500.

As illustrated in FIG. 8D, the setting screen 803 transitions to the item list screen 801. After the item list screen 801 transitions to the setting screen 803, and if the user releases the touch without performing a “touch move”, the setting screen 803 returns to the item list screen 801 in the state where the setting value remains unchanged. As described above, even if the pressing force weakens during a “touch move”, the setting screen 803 does not return to the item list screen 801. Then, based on performance of a “touch-up”, the setting value is changed. Thus, a setting unintended by the user is not made due to the weakening of the pressing force during the “touch move”. In other words, when the user performs a “touch move” to change a setting value, the current screen does not return to the previous screen in the state where the setting value cannot be changed against the user's intention. If the user intentionally performs a “touch-up”, the setting value is changed.

The processing described in the above exemplary embodiments can be applicable to the following cases:
setting item to be changed is to be volume when detected pressure becomes a first pressure level, and setting item to be changed is to be reproduction position when detected pressure becomes a second pressure level. The volume or reproduction position are changed based on the movement of the touch position after the detected pressure becomes the first or second level. While the touch position is moving, setting item to be changed is not changed, but once the touch position is stopped for a while and the detected pressure becomes another pressure level, setting item to be changed is changed.
setting item to be changed is to be reproduction position in a song when detected pressure becomes a first pressure level, and setting item to be changed is to be song program when detected pressure becomes a second pressure level. When setting item to be changed becomes song program, a user can choose a song to reproduce by moving the touch position.
setting screen is changed based on the detected pressure. For example, displayed setting screen is changed to low rank hierarchy when the detected pressure becomes the first level, and displayed setting screen is changed to high rank hierarchy when the detected pressure becomes a second level that is smaller than the first level.

In the above exemplary embodiments, a case has been provided where, after the image is reduced (pressed) in step S404, the movement of the touch position is received in step S406. The exemplary embodiments, however, are not limited to this. Alternatively, after the movement of the touch position, processing based on an increase in the pressing force can be performed. More specifically, even if a pressing force greater than or equal to a predetermined magnitude is applied while a setting value or an item is being selected by a “touch move”, the setting is not changed, or processing is not executed. Then, if the “touch move” stops, and a pressing force greater than or equal to the predetermined magnitude is applied, the setting of the item is changed or processing is executed.

A displayed reproduction image, a displayed captured image, displayed text, or a displayed table can be pressed, thereby being enlarged. Then, if the magnification reaches a certain enlargement magnification, the magnification cannot be changed, regardless of a change in the pressing force. Then, if a “touch-up” is performed, the magnification can be changed back to the original magnification.

A single piece of hardware can control the entire apparatus, or a plurality of pieces of hardware can share the processing to control the entire apparatus.

While exemplary embodiments have been provided, these specific exemplary embodiments are not seen to be limiting. Various forms of the exemplary embodiments are applicable. The above exemplary embodiments can be appropriately combined with each other.

In the above exemplary embodiments, as an example, a case has been described with respect to the digital camera 100. This example is not limiting, and any electronic device that detects the movement of a touch position and a pressing force is applicable. For example, a personal computer (PC), a mobile phone terminal, a mobile image viewer, a digital photo frame, a music player, a game apparatus, an electronic book reader, a tablet PC, a smartphone, a projection apparatus, or a household electrical appliance apparatus including a display unit.

The above exemplary embodiments can also be achieved by performing the process of supplying software (a program) to achieve the above-described functions to a system or an apparatus via a network or various recording media, and causing a computer (or a central processing unit (CPU) or a microprocessor unit (MPU)) of the system or the apparatus to read and execute a program code. In this case, the program and a recording medium having stored therein the program constituting the exemplary embodiments.

According to the exemplary embodiments, it is possible to more suitably execute a function based on the operation of pressing an operation unit on which a touch operation can be performed.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-080542, filed Apr. 13, 2016, which is hereby incorporated by reference herein in its entirety.

What is claimed is:

1. An electronic device comprising:
a touch detection unit configured to detect a touch operation on an operation unit;
a press detection unit configured to detect at least whether a pressing force for the operation unit is small or large;
a reception unit configured to receive a movement operation of a touch position of the touch operation on the operation unit; and
a control unit configured to perform control so that a first function is executed based on receipt of the movement operation,
wherein the control unit performs control so that, in a case where a predetermined change in the pressing force is detected without a touch of the touch operation being released after receipt of the movement operation, a second function is not executed when the predetermined change is detected, and
wherein the control unit performs control so that, in a case where the predetermined change is detected before the movement operation, the second function is executed when the predetermined change is detected.

2. The electronic device according to claim 1, wherein the control unit performs control so that in a case where, after the second function is executed based on the predetermined change, the reception unit receives the movement operation, a function corresponding to the movement operation is executed.

3. The electronic device according to claim 1, wherein the control unit performs control so that the second function is not executed based on a change in the pressing force of a press on the operation unit performed while the touch is not released after receipt of the movement operation.

4. The electronic device according to claim 1, wherein the control unit performs control so that, in a case the reception unit receives the movement operation, if the predetermined change is detected in a pressing force for the operation unit by another touch started after the touch is released from the operation unit, the second function is executed.

5. The electronic device according to claim 1, wherein the predetermined change in the pressing force is a change in which the pressing force decreases.

6. The electronic device according to claim 1, wherein the second function is a function of changing a display magnification of a display target displayed on a display unit.

7. The electronic device according to claim 6, wherein the control unit performs control so that, if the predetermined change in the pressing force for the operation unit is a change in which the pressing force increases, the display magnification of the display target is made smaller, and if the predetermined change in the pressing force for the operation unit is a change in which the pressing force decreases, the display magnification of the display target is made greater.

8. The electronic device according to claim 7, wherein the first function is a function executed if, after a function based on an increase in the pressing force is executed, the reception unit receives the movement operation and the first function is a function of selecting a partial area included in the display target.

9. The electronic device according to claim 8, wherein the control unit performs control so that, after the first function is executed, based on an operation of releasing the touch being performed, an area in the display target selected by the first function is displayed in an enlarged manner.

10. The electronic device according to claim 8, wherein the control unit performs control so that, based on an operation of releasing the touch being performed, an area in the display target selected by the first function is displayed at a display magnification used before a press on the operation unit causing execution of the second function.

11. The electronic device according to claim 8, wherein the control unit performs control so that, when the reception unit receives the movement operation after the function based on an increase in the pressing force is executed, the display target is moved while a mark indicating a partial area that is included in the display target and selected by the first function is not moved.

12. The electronic device according to claim 8, wherein the control unit performs control so that, when the reception unit receives the movement operation after the function based on an increase in the pressing force is executed, a mark indicating a partial area that is included in the display target and selected by the first function is moved, and the display target is not moved.

13. The electronic device according to claim 7, wherein the control unit performs control so that, in a case where the pressing force for the operation unit increases and the display magnification of the display target is made smaller, a mark indicating a partial area included in the display target is displayed.

14. The electronic device according to claim 13, wherein the control unit performs control so that, in a case where the pressing force for the operation unit increases, and the display magnification of the display target is made smaller, the mark is displayed at a position indicating an area in the display target displayed on the display unit before the pressing force increases.

15. The electronic device according to claim 6, wherein the display target includes a reproduction image, a map, text, a web page, a document, or a table.

16. The electronic device according to claim 1, wherein the first function is a function of changing a range included in a display target and displayed on a display unit.

17. The electronic device according to claim 1, wherein the first function is either a function of selecting an item or a function of changing a parameter.

18. The electronic device according to claim 1, wherein the second function is either a function of determining a selected item or a function of displaying a selected display target on a display unit.

19. The electronic device according to claim 1,
wherein an operation for executing the second function is received on a first screen displayed on a display unit, and
wherein an operation for executing the first function can be received on a second screen displayed on the display unit by executing the second function.

20. The electronic device according to claim 1,
wherein the control unit performs control so that, after receipt of the movement operation, if the predetermined change is detected in the pressing force of a press on the operation unit performed without the touch being released from the operation unit, the second function is not executed if the predetermined change in the pressing force is less than a predetermined magnitude, and
wherein the control unit performs control so that, after receipt of the movement operation, if the predetermined change is detected in the pressing force of a press on the operation unit performed without the touch being released from the operation unit, and the predetermined change in the pressing force is greater than or equal to the predetermined magnitude, the second function is executed.

21. The electronic device according to claim 1, wherein, in a case where a change in a magnitude of the pressing force exceeds a threshold, it is determined that the predetermined change is detected.

22. The electronic device according to claim 1, wherein the operation unit is a display surface of a display unit.

23. An electronic device comprising:
a touch detection unit configured to detect a touch operation on an operation unit;
a press detection unit configured to detect at least whether a pressing force for the operation unit is small or large; and
a control unit configured to perform control so that, based on a predetermined change in the pressing force, a display magnification of a display target displayed on a display unit is changed,
wherein the control unit performs control so that, when the display target is displayed at a first magnification, the display target is displayed at a second magnification that is smaller than the first magnification based on an increase in the pressing force, and then, based on release of a touch of the touch operation, the display target is displayed at the first magnification.

24. The electronic device according to claim 23, further comprising a selection unit configured to select a partial area in the display target based on a movement operation of a touch position of the detected touch operation,
wherein the control unit performs control so that, based on the movement operation performed when the display target is displayed at the second magnification, a mark indicating the selected partial area is displayed, and, based on release of the touch, the partial area indicated by the mark is displayed at the first magnification.

25. An electronic device comprising:
a detection unit configured to detect a touch operation on an operation unit;
a press detection unit configured to detect at least whether a pressing force for the operation unit is small or large; and
a control unit configured to perform control to change a display magnification of a display target displayed on a display unit,
wherein the control unit performs control so that, when the pressing force of a press on the operation unit started in a case where the display magnification of the display target is smaller than a predetermined magnification increases, the display magnification is made greater, and
wherein the control unit performs control so that, when the pressing force of a press on the operation unit started in a case where the display magnification of the display target is greater than the predetermined magnification increases, the display magnification is made smaller.

26. A method for controlling an electronic device, the method comprising:
detecting a touch operation on an operation unit;
detecting at least whether a pressing force for the operation unit is small or large;
receiving a movement operation of a touch position of the touch operation on the operation unit; and
performing control so that a first function is executed based on receipt of the movement operation,
wherein control is performed so that, in a case where a predetermined change in the pressing force is detected without a touch of the touch operation being released after receipt of the movement operation, a second function is not executed when the predetermined change is detected, and
wherein control is performed so that, in a case where the predetermined change is detected before the movement operation, the second function is executed when the predetermined change is detected.

27. A method for controlling an electronic device, the method comprising:
detecting a touch operation on an operation unit;
detecting at least whether a pressing force for the operation unit is small or large; and
performing control so that, based on a predetermined change in the pressing force, a display magnification of a display target displayed on a display unit is changed,
wherein control is performed so that, when the display target is displayed at a first magnification, the display target is displayed at a second magnification that is smaller than the first magnification based on an increase in the pressing force, and then, based on release of a touch of the touch operation, the display target is displayed at the first magnification.

28. A method for controlling an electronic device, the method comprising:
detecting a touch operation on an operation unit;
detecting at least whether a pressing force for the operation unit is small or large; and
performing control to change a display magnification of a display target displayed on a display unit,
wherein control is performed so that, when the pressing force of a press on the operation unit started in a case where the display magnification of the display target is smaller than a predetermined magnification increases, the display magnification is made greater, and
wherein control is performed so that, when the pressing force of a press on the operation unit started in a case where the display magnification of the display target is greater than the predetermined magnification increases, the display magnification is made smaller.

29. A non-transitory computer readable storage medium storing a program for causing a computer to execute a method for controlling an electronic device, the method comprising:
detecting a touch operation on an operation unit;
detecting at least whether a pressing force for the operation unit is small or large;
receiving a movement operation of a touch position of the touch operation on the operation unit; and
performing control so that a first function is executed based on receipt of the movement operation,
wherein control is performed so that, in a case where a predetermined change in the pressing force is detected without a touch of the touch operation being released after receipt of the movement operation, a second function is not executed when the predetermined change is detected, and
wherein control is performed so that, in a case where the predetermined change is detected before the movement operation, the second function is executed when the predetermined change is detected.

30. A non-transitory computer readable storage medium storing a program for causing a computer to execute a method for controlling an electronic device, the method comprising:
detecting a touch operation on an operation unit;
detecting at least whether a pressing force for the operation unit is small or large; and
performing control so that, based on a predetermined change in the pressing force, a display magnification of a display target displayed on a display unit is changed,
wherein control is performed so that, when the display target is displayed at a first magnification, the display target is displayed at a second magnification that is smaller than the first magnification based on an increase in the pressing force, and then, based on release of a touch of the touch operation, the display target is displayed at the first magnification.

31. A non-transitory computer readable storage medium storing a program for causing a computer to execute a method for controlling an electronic device, the method comprising:
detecting a touch operation on an operation unit;
detecting at least whether a pressing force for the operation unit is small or large; and
performing control to change a display magnification of a display target displayed on a display unit,
wherein control is performed so that, when the pressing force of a press on the operation unit started in a case where the display magnification of the display target is smaller than a predetermined magnification increases, the display magnification is made greater, and
wherein control is performed so that, when the pressing force of a press on the operation unit started in a case where the display magnification of the display target is greater than the predetermined magnification increases, the display magnification is made smaller.
